(19) United States
(12) Patent Application Publication
(10) Pub. No.: US 2023/0340967 A1
(43) Pub. Date: Oct. 26, 2023

(54) ACCUMULATOR

(71) Applicant: UGT GROUP PTY LTD, Swan View (AU)

(72) Inventor: Max SCOTT, Perth (AU)

(21) Appl. No.: 17/920,361

(22) PCT Filed: Jan. 21, 2021
(86) PCT No.: PCT/AU2021/050033

§ 371 Date: Oct. 20, 2022

(30) Foreign Application Priority Data
Jan. 21, 2020 (AU) 2020900155

(51) Int. Cl. F15B 1/04; F15B 1/02

(52) U.S. Cl. CPC F15B 1/04; F15B 1/021; F15B 2201/3155; F15B 2201/405

(57) ABSTRACT

The present invention provides an accumulator (20) comprising a housing (21), an inner portion (23) within the housing, and a zone (27) defined between the housing and the inner portion for fluid communication with a driving fluid of a fluid-powered system whereby the inner portion is exposed to the driving fluid received within the zone. The inner portion comprises a resiliently deformable solid mass (31), wherein at least a portion of the mass is deformable in response to fluid pressure in the zone exceeding a prescribed level thereby to provide pressure relief. The deformable portion resiliently rebounds in response to fluid pressure in the zone returning to or falling below the prescribed level.

### CROSS-REFERENCE TO RELATED APPLICATIONS

This application is a National Phase Entry of PCT/AU2021/050033, filed on Jan. 21, 2021, entitled Accumulator. PCT/AU2021/050033 claims priority from and benefit of Australian Application No. 2020900155, filed on Jan. 21, 2020, entitled Accumulator. Each of these prior applications are incorporated herein by reference in their entirety and for all purposes.

### TECHNICAL FIELD

The present invention relates to an accumulator for a fluid-powered system and also parts thereof.

### BACKGROUND ART

The following discussion of the background art is intended to facilitate an understanding of the present invention only. The discussion is not an acknowledgement or admission that any of the material referred to is or was part of the common general knowledge as at the priority date of the application.

Fluid-powered systems are used to operate fluid-actuated devices, such as for example hydraulic and pneumatic motors, and hydraulic and pneumatic impact devices. Such impact devices may be in a variety of forms, such as rock-drilling machines, jack hammers and chisel hammers.

In a fluid-powered system, a driving fluid (such as hydraulic oil or air) is delivered under pressure from a power source (such as a pump or compressor) to the fluid-actuated device. Pressure pulsations, such as fluid shock waves, can arise in the driving fluid between the power source and the fluid-actuated device. These pressure pulsations can potentially cause damage to the fluid-powered system (including in particular the high pressure fluid flow line(s) used in the system) and may also represent a loss of energy available to the fluid-actuated device.

With a view to damping the pressure pulsations, it is common to provide an accumulator in the fluid-powered system, as would be understood by a person skilled in the art.

One known form of accumulator comprises a bladder-type accumulator which features a pressure vessel having an internal bladder which divides the interior of the pressure vessel into a first section within the bladder charged with pressurised gas, and a second section about the bladder for communication with the hydraulic system to receive driving fluid. The first section (within the bladder) is precharged to a selected pressure, having regard to the performance requirements of the fluid-powered system. If, during operation of the fluid-powered system, fluid pulsation within the driving fluid (e.g. hydraulic oil or compressed air) causes the fluid pressure to exceed the selected pressure, the driving fluid will enter the second section (about the bladder) and act against the bladder, compressing the gas and thereby damping the pressure pulsation.

The bladder tends to lose pressure over time, and consequently requires recharging periodically. For instance, in the case of rock drilling it may not be uncommon for a bladder-type accumulator to have scheduled maintenance weekly, at which time the unit would be tested to ensure that it is operating at the required pressure.

In certain hydraulic systems, it is known to provide an accumulator having a replaceable cartridge incorporating a bladder pre-charged with gas. With this arrangement, the cartridge is intended to be replaced, rather than recharged, when the bladder has lost pressure to an extent that it no longer performs effectively. While this provides a convenient way of replenishing the accumulator with gas, it may not be cost-effective in circumstances where spent cartridges are required to be exchanged frequently.

It is against this background that the present invention has been developed.

### SUMMARY OF INVENTION

According to a first aspect of the invention there is provided an accumulator comprising a housing, an inner portion within the housing, a zone defined between the housing and the inner portion for fluid communication with a driving fluid of a fluid-powered system whereby the inner portion is exposed to the driving fluid received within the zone, the inner portion comprising a resiliently deformable solid mass, wherein at least a portion of the mass is deformable in response to fluid pressure in the zone exceeding a prescribed level thereby to provide pressure relief and wherein the deformable portion resiliently rebounds in response to fluid pressure in the zone returning to or falling below the prescribed level.

With this arrangement, fluid pressure fluctuations in the driving fluid involving pressure exceeding the prescribed level are dampened.

The resiliently deformable solid mass may be resiliently compressible.

The resiliently deformable solid mass may be of a material having properties (such as for example density) selected having regard to the prescribed level of pressure of the driving fluid at which pressure relief is to be provided. The density of the resiliently deformable solid mass may be directly representative of resistance to deformation in response to fluid pressure.

In practical terms, the density of the resiliently deformable solid mass may be considered to correspond directly to the gas charge that would normally be applied to the bladder of a bladder-type accumulator.

Density testing may be performed to determine/select the material appropriate for the intended purpose. By way of example, a Shore Durometer may be used to test the density of the resiliently deformable solid mass, with testing conducted to determine/select material having an appropriate density.

By way of example, the material selected may have a density of about one-third of the prescribed level of pressure at which pressure relief is to be provided.

The resiliently deformable solid mass may comprise a resiliently deformable mass of cellular material. The resiliently deformable solid mass of cellular material may comprise a single body of cellular material or an aggregation of a plurality of bodies of cellular material. Where there is an aggregation of a plurality of bodies of cellular material, the bodies may be of the same cellular material or two or more different cellular materials. Further, the bodies may have the same densities or different densities.

The resiliently deformable solid mass of cellular material may comprise foam material. The foam may comprise a polymer foam such as polyurethane foam. More particularly, the polyurethane foam may comprise a two-pack Cold Cast Polyurethane. Other types of foam material are contemplated.

The material selected for use as the resiliently deformable solid mass may be of a type that can be formulated or otherwise tailored to provide characteristics appropriate for the intended purpose. For instance, it is believed that polyurethane foam is particularly suitable for use as the resiliently deformable solid mass of cellular material, as its composition can be selectively varied to provide an accumulator with performance characteristics to suit the requirements of a particular hydraulic system in which it is to operate.

The resiliently deformable solid mass may be accommodated within a rigid casing. The resiliently deformable solid mass may be incorporated in or configured as an insert receivable in the casing. The inset may be selectively removable from the casing.

The casing may be configured to allow fluid communication between the zone and the resiliently deformable solid mass. The casing may be so configured by way of one or more flow openings in the casing.

The casing may comprise a body defining a hollow interior for accommodating the resiliently deformable solid mass.

The resiliently deformable solid mass may be sized and shaped to be a close fit within the hollow interior of the body.

The body of the casing may comprise side wall means bounding the hollow interior. The side wall means may comprise a cylindrical side wall.

The casing may comprise a plurality of said flow openings, wherein the flow openings are provided in the side wall means.

The body of the casing may further comprise opposed end sections between which the side wall means extend, one end section being closed and the other end section being open for access to the hollow interior of the body.

The resiliently deformable solid mass may be received with a sheath supported within the hollow interior of the body of the casing. The sheath may be formed or configured to facilitate transfer of pressure between driving fluid and the resiliently deformable solid mass. The sheath may be formed of a flexible material to facilitate such transfer of pressure between driving fluid and the resiliently deformable solid mass.

The sheath may be configured as a sock in which the resiliently deformable solid mass is receivable.

The sheath may be adapted for attachment to the casing. Where the sheath is configured as a sock, the sock may be adapted for attachment to the casing by way of the open end portion of the sock being attached to the casing.

The sheath and the resiliently deformable solid mass together may be sized and shaped to be a close fit within the hollow interior of the body. More particularly, the sheath may abut the side wall means of the body when the sheath and the resiliently deformable solid mass are accommodated within the hollow interior of the body.

The casing may further comprise a removable end portion for closing the open end section of the body.

The removable end portion may comprise an inner end section adapted to be received in the open end section of the body and an outer end section.

The inner end section may be configured as a plug receivable in the open end section of the body.

The sheath may be attached to the inner end section of the removable end portion of the casing. Where the sheath is configured as a sock, the sock may be adapted for attachment to the inner end section by way of the open end portion of the sock. More particularly, the open end portion of the sock may be adapted to be received and retained on the inner end section.

The casing may be configured to be removably received in the housing of the accumulator. More particularly, the removable end portion of the casing may be adapted for attachment to the housing to facilitate mounting of the casing within the housing.

The casing may be provided with buffers at its opposite ends to provide cushioning within the housing.

According to a second aspect of the invention there is provided an inner portion for an accumulator according to the first aspect of the invention.

The inner portion according to the second aspect of the invention may have any one or more of the features recited above in relation to the inner portion of the accumulator according to the first aspect of the invention.

According to a third aspect of the invention there is provided an insert for an accumulator, the insert comprising a resiliently deformable solid mass.

The insert may be receivable in a casing. The inset may be selectively removable from the casing.

The casing may be configured to allow fluid communication between a zone within the accumulator and the resiliently deformable solid mass.

The casing may comprise a body defining a hollow interior for accommodating the resiliently deformable solid mass.

The resiliently deformable solid mass may be received within a sheath supported within the hollow interior of the body of the casing. The sheath may be formed or configured to facilitate transfer of pressure with respect to the resiliently deformable solid mass. The sheath may be formed of a flexible material to facilitate such transfer of pressure.

The insert according to the third aspect of the invention may have any one or more of the features recited above in relation to the insert of the accumulator according to the first aspect of the invention.

### BRIEF DESCRIPTION OF THE DRAWINGS

Further features of the present invention are more fully described in the following description of a non-limiting embodiment thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic view of a hydraulic system incorporating an embodiment of an accumulator according to the invention;

FIG. 2 is a partly-sectioned side view of an inner portion of the accumulator;

FIG. 3 is a schematic view of the inner portion shown in FIG. 2 in an exploded condition;

FIG. 4 is a perspective view of a body forming part of a casing of the inner portion;

FIG. 5 is a schematic side view of the body of the casing;

FIG. 6 is a sectional side view of the body of the casing;

FIG. 7 is a perspective view of a sheath forming part of the inner portion;

FIG. 8 is a sectional side view of the sheath;

FIG. 9 is a perspective view of a removable end portion of the casing; and

FIG. 10 is a side view of the removable end portion of the casing.

The drawings shown are not necessarily to scale, with emphasis instead generally being placed upon illustrating the principles of the present disclosure.

The figures depict an embodiment exemplifying the principles of the present disclosure. The embodiment illustrates a certain configuration; however, it is to be appreciated that the inventive principles can be implemented by way of many different configurations, as would be obvious to a person skilled in the art, whilst still embodying any of the inventive principles. These configurations are to be considered within the embodiment described herein.

### DESCRIPTION OF EMBODIMENT

In the following detailed description, the present invention is described in connection with a preferred embodiment. However, to the extent that the following description is specific to a particular embodiment or a particular use of the present techniques, it is intended to be illustrative only and merely provides a concise description of the exemplary embodiment. Accordingly, the present invention is not limited to the specific embodiment described below, but rather the invention includes all alternatives, modifications, and equivalents falling within the true scope of the appended claims.

The embodiment will be described with reference to a hydraulic system 10 for operating a fluid-actuated device (not shown), such as for example a hydraulic impact device. The hydraulic system 10 includes a pump 11 for receiving driving fluid (in the form of hydraulic oil) from a tank (not shown) via low pressure fluid supply line 13, and delivering the driving fluid under pressure to the fluid-actuated device via high pressure fluid delivery line 15.

The hydraulic system 10 also includes a hydraulic accumulator 20 for damping pressure pulsations which might arise in the fluid delivery line 15 during operation of the fluid-actuated device, as would be understood by a person skilled in the art. The hydraulic accumulator 20 is in fluid communication with the high pressure fluid delivery line 15 via branch line 19.

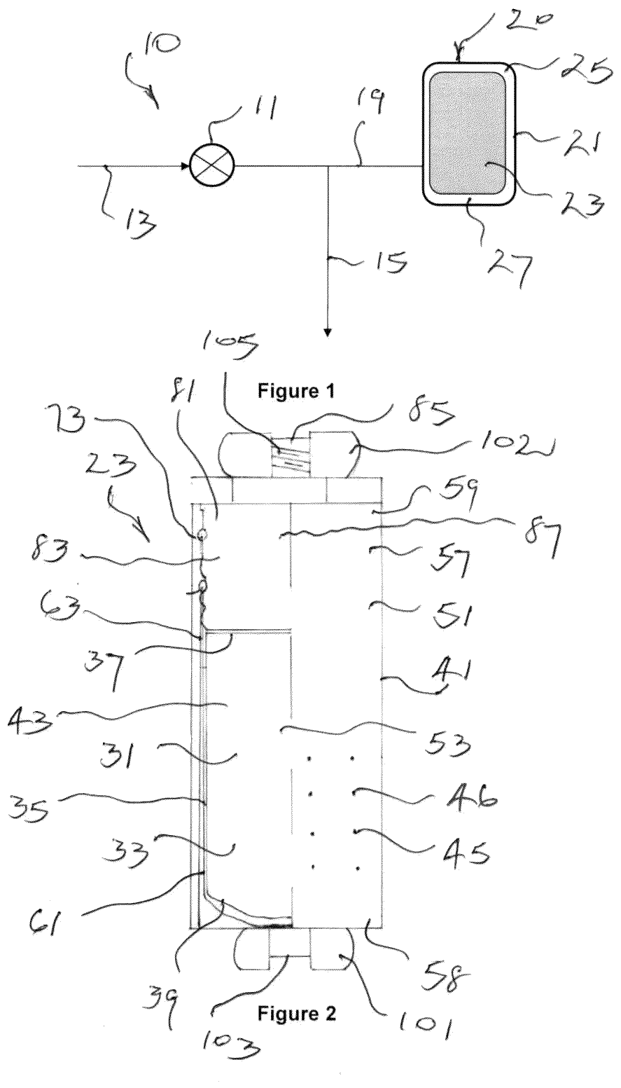

The hydraulic accumulator 20 comprises a housing 21 and an inner portion 23, as shown in FIG. 1.

The housing 21 defines an interior compartment 25 in which the inner portion 23 is received and mounted. The interior compartment 25 is in fluid communication with the high pressure fluid delivery line 15 via the branch line 19. As such, the interior compartment 25 receives driving fluid (hydraulic oil) from the high pressure fluid delivery line 15. Because of the fluid pressure to which the interior compartment 25 is exposed during operation of the hydraulic system 10, the housing 21 is preferably configured as a pressure vessel.

With the inner portion 23 received within the housing 21, a zone 27 is defined between the housing 21 and the inner portion 23 for fluid communication with the driving fluid (hydraulic oil). With this arrangement, the inner portion 23 is exposed to driving fluid (hydraulic oil) received within the zone 27.

The inner portion 23 comprising a resiliently deformable solid mass 31, at least a portion of which is deformable in response to fluid pressure in the zone 27 exceeding a prescribed level, thereby to provide pressure relief. The deformable portion is adapted to resiliently rebound in response to fluid pressure in the zone 27 returning to or falling below the prescribed level. In this way, fluid pressure pulsations in the high pressure fluid delivery line 15 (represented by pressure exceeding the prescribed level) are dampened.

The resiliently deformable solid mass 31 comprises a body 33 of resiliently compressible cellular material. In this embodiment, the body 33 is formed of polyurethane. The particular polyurethane chosen for use to provide the resiliently deformable solid mass 31 may have properties (such as for example density) selected having regard to the prescribed level of pressure of the driving fluid (hydraulic oil) at which pressure relief is to be provided. In this embodiment, the polyurethane foam may comprise a two-pack Cold Cast Polyurethane, with a standard mix as recommended by the product manufacturer having a density of about 45 Duro and a custom mixture used in production of resiliently compressible cellular material for the body 33 of this embodiment having a density of about 68 Duro.

Polyurethane foam is considered to be particularly suitable for use as the body 33 of resiliently compressible cellular material, as its composition can be selectively varied to provide the accumulator 20 with performance characteristics to suit the requirements of the hydraulic system 10. By way of example, the polyurethane selected may have a density of about one-third of the prescribed level of pressure in the high pressure fluid delivery line 15 at which pressure relief is to be provided. This relationship between the density of the resiliently deformable solid mass 31 and the prescribed level of pressure in the high pressure fluid delivery line 15 at which pressure relief is to be provided, is presented for indicative purposes only and should not be considered to be limiting in any way. Other relationships are of course contemplated, having regard to the desired performance characteristics of the accumulator 20 with respect to the hydraulic system 10.

In this embodiment, the resiliently deformable solid mass 31 comprise a single body 33. In another embodiment (not shown), the resiliently deformable solid mass 31 may comprise an aggregation of a plurality of bodies of cellular material. Where there is an aggregation of a plurality of bodies of cellular material, the bodies may be of the same cellular material or two or more different cellular materials. Further, the bodies may have the same densities or different densities.

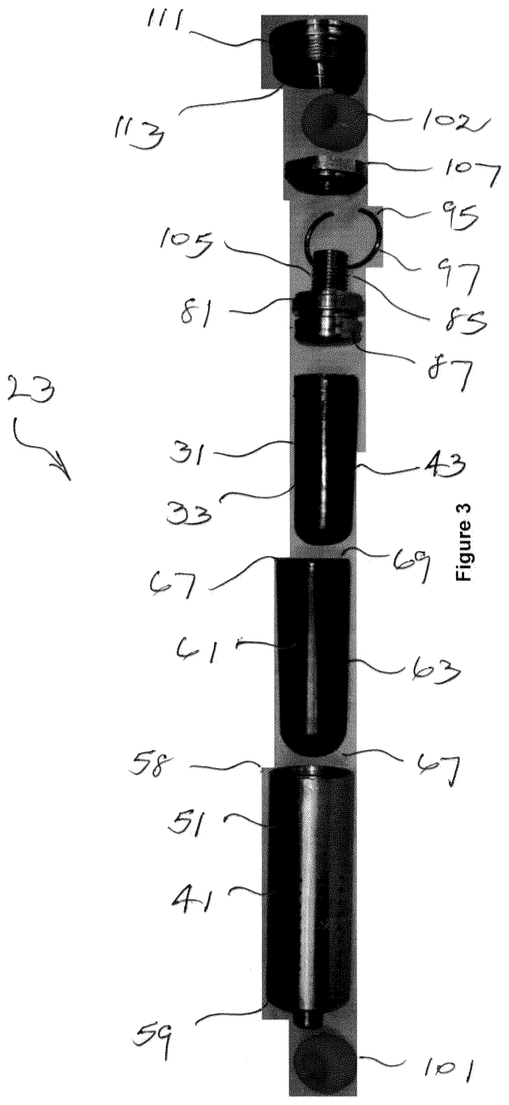

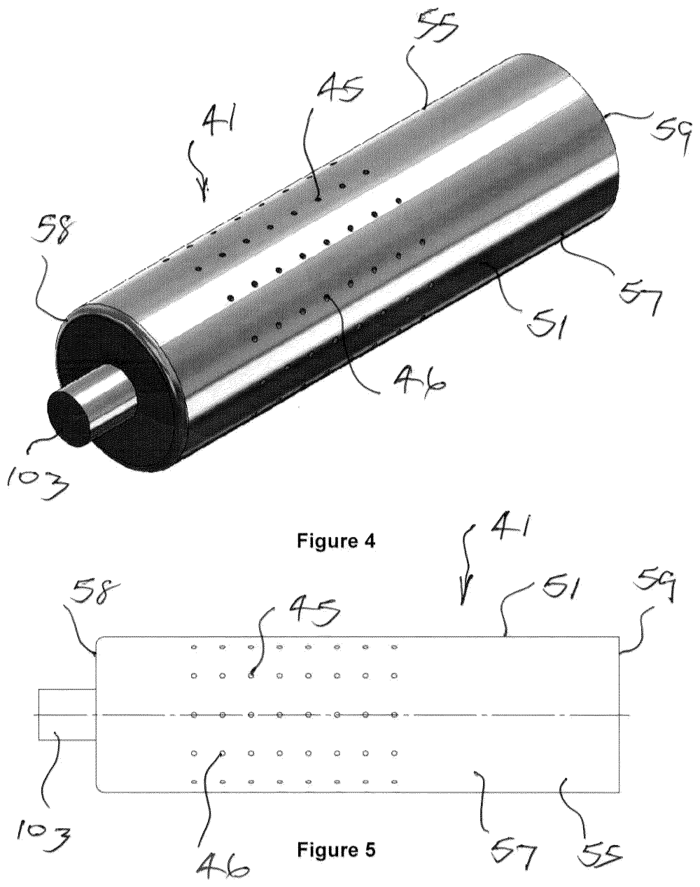

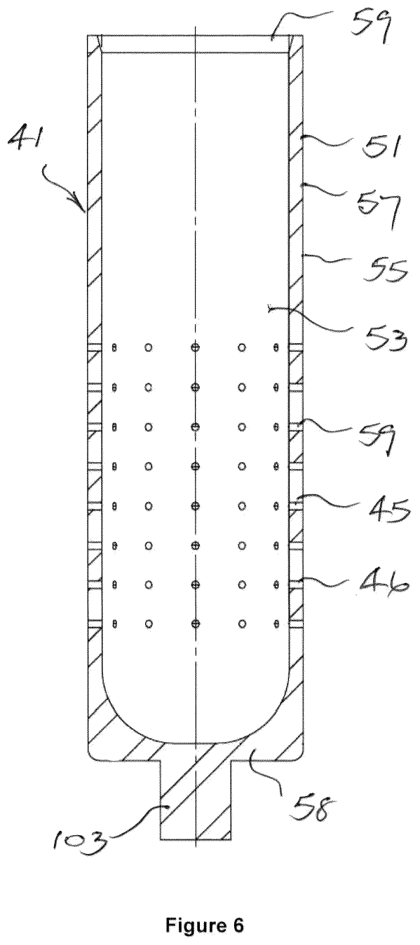

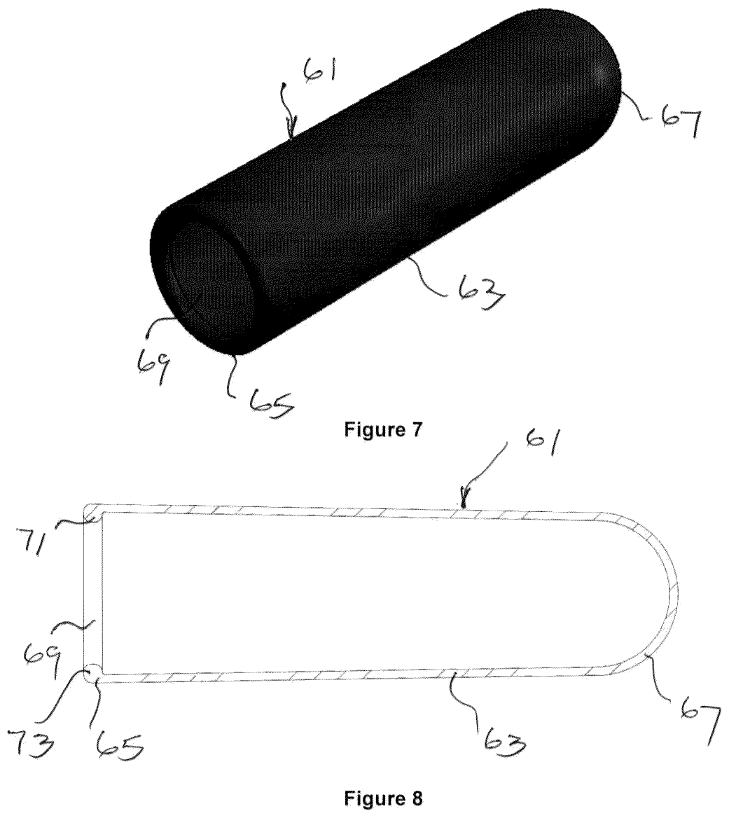

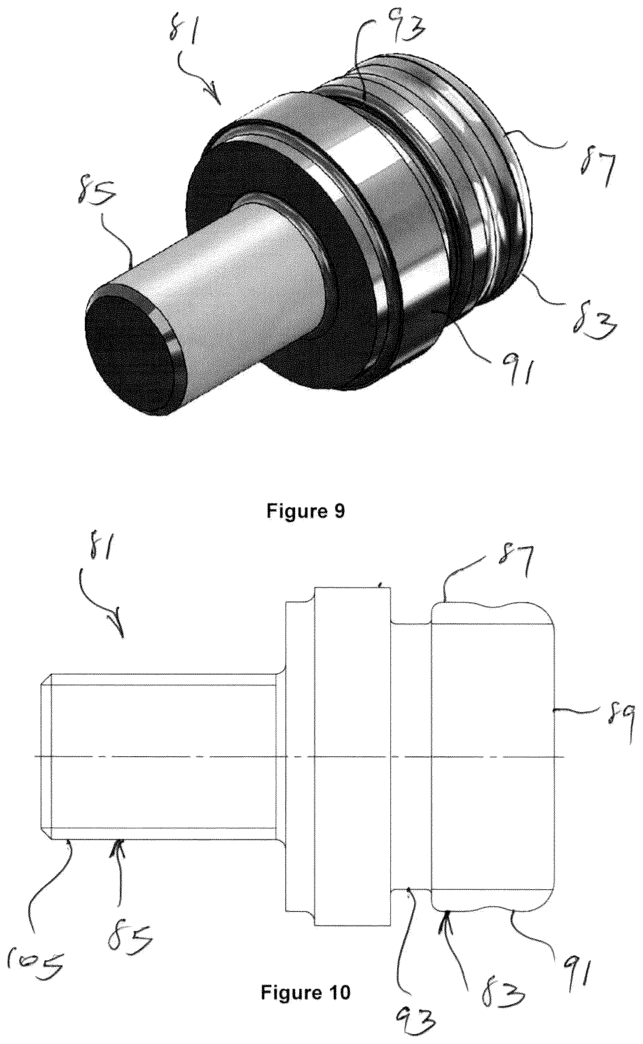

The resiliently deformable body 33 comprises a side surface 35, a top surface 37 and a bottom surface 39. In the arrangement shown, the body 33 is of generally cylindrical configuration, with side surface 35 being circular. The top surface 37 is flat, and the bottom surface 39 is of a rounded configuration, as best seen in FIGS. 2 and 3.

The resiliently deformable body 33 is accommodated within a rigid casing 41. More particularly, the resiliently deformable body 33 is incorporated in or configured as an insert 43 receivable in the casing 41. The inset 43 may be selectively removable from the casing 41 for replacement, if and when necessary.

The casing 41 is configured to allow fluid communication between the zone 27 within the housing 21 and the resiliently deformable body 33. More particularly, the casing 41 is so configured by provision of flow openings 45 in the casing.

The casing 41 comprise a body 51 defining a hollow interior 53 for accommodating the resiliently deformable body 33.

The resiliently deformable body 33 is sized and shaped to be a close fit within the hollow interior 53 of the body 51 of the casing 41.

The body 51 of the casing 41 comprise side wall means 55 bounding the hollow interior 53. In the arrangement shown, the side wall means 55 comprise a cylindrical side wall 57. The flow opening 45 in the casing 41 comprise a plurality of holes or ports 46 in the cylindrical side wall 57.

The body 51 of the casing 41 further comprise opposed end sections 58, 59 between which the cylindrical side wall 57 extends. One end section 58 is closed and the other end section 59 is open for access to the hollow interior 53 of the body 51.

The resiliently deformable body 33 is snugly received within a sheath 61 supported within the hollow interior 53 of the body 51. The sheath 61 is formed or configured to facilitate transfer of pressure between driving fluid (hydraulic oil) and the side surface 35 of the resiliently deformable body 33. More particularly, the sheath 61 is formed of a flexible material to facilitate such transfer of pressure between driving fluid (hydraulic oil) and the side surface 35 of the resiliently deformable body 33.

The sheath 61 is configured as a sock 63 to snugly receive the resiliently deformable body 33. The sock 63 has an open end portion 65 and a closed end portion 67. The open end portion 67 includes an opening 69 and a peripheral edge 71 bounding the opening 69. The peripheral edge 71 incorporates an inwardly projecting lip 73 which provides a circumferential locating rib 75. The closed end portion 67 is rounded to conform generally to the rounded bottom surface 39 of the resiliently deformable body 33.

The sheath 61 is adapted for attachment to the casing 41, as will be explained in more detail later.

The sheath 61 and the resiliently deformable body 33 together are sized and shaped to be a close fit within the hollow interior 53 of the body 51. More particularly, the sheath 61 abuts the cylindrical side wall 57 of the body 51 when sheath 61 and the resiliently deformable body 33 are accommodated within the hollow interior 53, as shown in FIG. 2.

The casing 41 further comprise a removable end portion 81 for closing the open end section 59 of the casing body 51. The removable end portion 81 comprises an inner end section 83 adapted to be received in the open end section 59 of the body 51 and an outer end section 85.

The inner end section 83 is configured as a plug 87 receivable in the open end section 59 of the body 51. The plug 87 has an inner face 89, a side face 91 and a circumferential groove 93 in the side face 91.

The sheath 61 is attached to the inner end section 83 of the removable end portion 81 of the casing 41. More particularly, the sock 63 is adapted for attachment to the plug 87 by way of the open end portion 65 of the sock 63. Specifically, the open end portion 65 of the sock is adapted to be received and retained on the plug 87, with the locating rib 75 on the sock 63 being received and retained in the circumferential groove 93.

A fastener 95 is provided to secure the sheath 61 to the plug 87. In the arrangement shown, the fastener 95 is configured as a circlip 97.

When the plug 87 is received with the open end section 59 of the body 51 and the sheath 61 accommodating the resiliently deformable body 33 is in place, the inner face 89 of the plug 83 engages the top surface 37 of the body 33, as shown in FIG. 2. In this way, the resiliently deformable body 33 is confined within the sheath 61 immediately below the plug 87.

The casing 41 is configured to be removably received in the housing 21 of the hydraulic accumulator 20. More particularly, the removable end portion 81 of the casing 41 is adapted for attachment to the housing 21 to facilitate mounting of the casing 51 within the housing 21.

The casing 41 is provided with two buffers 101, 102 at its opposite ends to provide cushioning within the housing 21. [[.]] Buffer 101 is located on a spigot 103 provided on closed end section 58 of the casing 41. Buffer 102 is located on a spigot 105 provided on outer end section 85 of the removable end portion 81 of the casing 41. The spigot 105 is threaded to receive a nut 107 for holding the buffer 102 in place.

The removable end portion 81 is releasably attached to the open end section 59 of the body 51 of the casing 41. In the arrangement shown, the removable end portion 81 is releasably attached to open end section 59 the body 51 by way of a retainer 111 adapted to locate against the inner end section 83 of the removable end portion 81 and threadingly engage the open end section 59 the body 51 of the casing 41. The retainer 111 includes a central opening 113 through which the outer end section 85 of the removable end portion 81 extends to receive the buffer 102 and also to facilitate mounting of the casing 51 within the housing 21.

If, during operation of the hydraulic system 10, fluid pulsation in the high pressure fluid delivery line 15 causes fluid pressure to exceed the selected pressure, the driving fluid (hydraulic oil) within the interior compartment 25 of the housing 21 (and more particularly in zone 27 as defined between the housing 21 and the inner portion 23) is caused to act upon the resiliently deformable body 33 with greater force, causing the body 33 to deform (compress) and thereby provide pressure relief to dampen the pressure pulsation. The resiliently deformable body 33 resiliently rebounds in response to fluid pressure in the high pressure fluid delivery line 15 returning to or falling below the prescribed level.

In this process, fluid pressure is transmitted between the interior compartment 25 of the housing 21 and the resiliently deformable body 33 though the holes or ports 46 in the cylindrical side wall 57 of the body 51 and through the flexible sheath 61.

It should be noted that the resiliently deformable body 33 is exposed to fluid pressure in the interior compartment 25 of the housing 21 at all times during which the hydraulic system 10 is operating and the high pressure fluid delivery line 15 is pressurised. However, it is only when the fluid pulsation in the high pressure fluid delivery line 15 causes the fluid pressure to exceed the selected pressure that the body 33 is caused to deform (compress) in response to the increased fluid pressure and thereby provide pressure relief to dampen the pressure pulsation.

As previously mentioned, the resiliently deformable body 33 is a snug fit in the flexible sheath 61 and the flexible sheath 61 itself abuts the rigid casing 41, with fluid pressure being transmitted between the interior compartment 25 of the housing 21 and the resiliently deformable body 33 through the holes or ports 46 in the casing 41 and through the flexible sheath 61. With this arrangement, deflection of the flexible sheath 61 occurs only upon deformation of the resiliently deformable body 33. This limitation to the extent of deflection of the flexible sheath 61 may be advantageous in terms of the service life of the sheath.

If over time the resilience of the resiliently deformable body 33 deteriorates to an extent that it no longer provides adequate compressive resistance and rebounding effects in response to pressure pulsations, the inner portion 23 could be simply replaced in its entirety or alternatively the insert 43 only might be replaced.

It will of course be understood that any pressure fluctuations in the high pressure fluid delivery line 15 are experienced also in the interior compartment 25 of the housing 21 (and more particularly in zone 27 as defined between the housing 21 and the inner portion 23) by virtue of the hydraulic accumulator 20 being in fluid communication with the high pressure fluid delivery line 15 via branch line 19.

The arrangement described herein featuring a resiliently deformable solid mass is advantageous as it avoids the need to provide a bladder precharged with gas (as required by prior art discussed previously), as well as the attendant need to periodically recharge the bladder.

The arrangement described herein featuring a resiliently deformable solid mass may be implemented through conversion or modification of the particular prior art arrangement described previously having a replaceable cartridge incorporating a bladder precharged with gas. The conversion or modification may involve substitution of a sheath containing a resiliently deformable solid mass for a bladder precharged with gas. Accordingly, the present invention contemplates modifying such prior art arrangements in a manner to provide an accumulator according to the present invention. In performing such a modification, it is contemplated that the bladder of the prior art arrangement could be used to provide the sheath, in which case the resiliently deformable body 33 would be inserted into the bladder.

The foregoing disclosure is intended to explain how to fashion and use the particular embodiment described, rather than to limit the true, intended, and fair scope and spirit of the present disclosure. The foregoing description is not intended to be exhaustive, nor to be limited to the precise forms disclosed.

It should be appreciated that various modifications can be made without departing from the principles described herein. Therefore, the principles should be understood to include all such modifications within its scope.

The terminology used herein is for the purpose of describing particular example embodiment only and is not intended to be limiting.

As used herein, the singular forms “a”, “an” and “the” may be intended to include the plural forms as well, unless the context clearly indicates otherwise.

The method steps, processes, and operations described herein are not to be construed as necessarily requiring their performance in the particular order discussed or illustrated, unless specifically identified as an order of performance. It is also to be understood that additional or alternative steps may be employed.

Reference to any positional descriptions, such as “top”, “bottom” and “side”, are to be taken in context of the embodiment described and are not to be taken as limiting the invention to the literal interpretation of the term but rather as would be understood by the skilled addressee.

Spatially relative terms, such as “inner”, “outer”, “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly indicated by the context. Thus, a first element, component, region, layer or section discussed below could be termed a second element, component, region, layer or section without departing from the teachings of the example embodiment.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on”, “directly engaged to”, “directly connected to” or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.). As used herein, the term “and/or” includes any and all combinations of one or more of the associated listed items.

Additionally, where the terms “system”, “device”, and “apparatus” are used in the context of the invention, they are to be understood as including reference to any group of functionally related or interacting, interrelated, interdependent or associated components or elements that may be located in proximity to, separate from, integrated with, or discrete from, each other.

Furthermore, in the embodiment described herein (including the following claims), the word “determining” is understood to include receiving or accessing the relevant data or information.

Throughout this specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

1. An accumulator comprising a housing, an inner portion within the housing, a zone defined between the housing and the inner portion for fluid communication with a driving fluid of a fluid-powered system whereby the inner portion is exposed to the driving fluid received within the zone, the inner portion comprising a resiliently deformable solid mass, wherein at least a portion of the mass is deformable in response to fluid pressure in the zone exceeding a prescribed level thereby to provide pressure relief and wherein the deformable portion resiliently rebounds in response to fluid pressure in the zone returning to or falling below the prescribed level.

2. (canceled)

3. The accumulator of claim 1, wherein the resiliently deformable solid mass is of a material having properties selected having regard to the prescribed level of the driving fluid at which pressure relief is to be provided.

4. The accumulator of claim 3, wherein the density of the resiliently deformable solid mass is directly representative of resistance to deformation in response to fluid pressure.

5. (canceled)

6. The accumulator of claim 3 wherein the material selected has a density of approximately one-third of the prescribed level at which pressure relief is to be provided.

7. The accumulator of claim 1, wherein the resiliently deformable solid mass comprises a resiliently deformable mass of cellular material wherein the resiliently deformable solid mass of cellular material comprises a single body of cellular material or an aggregation of a plurality of bodies of cellular material wherein the bodies are of the same cellular material, or two or more different cellular materials.

8. (canceled)

9. (canceled)

10. (canceled)

11. The accumulator of claim 7, wherein the material selected for use as the resiliently deformable solid mass is of a type that can be formulated or otherwise tailored to provide characteristics appropriate for the intended purpose.

12. (canceled)

13. The accumulator of claim 1, wherein the resiliently deformable solid mass is incorporated in or configured as an insert receivable in a rigid casing, the insert is selectively removable from the casing.

14. The accumulator of claim 13, wherein the casing is configured to allow fluid communication between the zone and the resiliently deformable solid mass.

15. (canceled)

16. The accumulator of claim 13, wherein the casing comprises a body defining a hollow interior for accommodating the resiliently deformable solid mass wherein the resiliently deformable solid mass is sized and shaped to be a close fit within the hollow interior of the body.

17. (canceled)

18. The accumulator according to claim 16 wherein the body of the casing comprises side wall means bounding the hollow interior.

19. (canceled)

20. The accumulator according to claim 18 wherein the casing comprises a plurality of flow openings, wherein the flow openings are provided in the side wall means.

21. The accumulator according to claim 18 wherein the body of the casing further comprises opposed end sections between which the side wall means extend, one end section being closed and the other end section being open for access to the hollow interior of the body, wherein the resiliently deformable solid mass is received within a sheath supported within the hollow interior of the body of the casing, wherein the sheath is formed or configured to facilitate transfer of pressure between driving fluid and the resiliently deformable solid mass.

22. (canceled)

23. (canceled)

24. The accumulator of claim 1, wherein the sheath is formed of a flexible material to facilitate such transfer of pressure between driving fluid and the resiliently deformable solid mass.

25. The accumulator of claim 21, wherein the sheath is configured as a sock in which the resiliently deformable solid mass is receivable, the sock being adapted for attachment to the casing by way of the open end portion of the sock being attached to the casing.

26. The accumulator of claim 21, wherein the sheath is adapted for attachment to the casing.

27. (canceled)

28. The accumulator of claim 21, wherein the sheath and the resiliently deformable solid mass together is sized and shaped to be a close fit within the hollow interior of the body, wherein the sheath abuts the side wall means of the body when the sheath and the resiliently deformable solid mass are accommodated within the hollow interior of the body.

29. (canceled)

30. The accumulator according of claim 21, wherein the casing further comprises a removable end portion for closing the open end section of the body, wherein the removeable end portion comprises an inner end section adapted to be received in the open end section of the body and an outer end section.

31. (canceled)

32. (canceled)

33. The accumulator of claim 30, wherein the sheath is attached to the inner end section of the removable end portion of the casing, wherein the sheath is configured as a sock, the sock is adapted for attachment to the inner end section by way of the open end portion of the sock, whereby the open end portion of the sock is adapted to be received and retained on the inner end section.

34. (canceled)

35. The accumulator of claim 13, wherein the casing is configured to be removably received in the housing of the accumulator.

36. The accumulator of claim 30, wherein the casing is configured to be removably received in the housing of the accumulator wherein the removable end portion of the casing is adapted for attachment to the housing to facilitate mounting of the casing within the housing.

37. (canceled)

38. (canceled)

39. (canceled)

40. An insert for an accumulator of claim 1, the insert comprising a resiliently deformable solid mass and is receivable in a casing such that it is removable therefrom; wherein the casing is configured to allow fluid communication between a zone within the accumulator and the resiliently deformable solid mass, the casing comprises a body defining a hollow interior for accommodating the resiliently deformable solid mass.

41. (canceled)

42. (canceled)

43. (canceled)

44. (canceled)

45. The insert of claim 40, wherein the resiliently deformable solid mass is received within a sheath supported within the hollow interior of the body of the casing.

46. The insert of claim 45, wherein the sheath is formed or configured to facilitate transfer of pressure with respect to the resiliently deformable solid mass.

47. The insert of claim 46, wherein the sheath is formed of a flexible material to facilitate such transfer of pressure.

48. (canceled)
